(19) United States
(12) Patent Application Publication
(10) Pub. No.: US 2012/0253803 A1
(43) Pub. Date: Oct. 4, 2012

(54) VOICE RECOGNITION DEVICE AND VOICE RECOGNITION METHOD

(76) Inventors: Motonobu Sugiura, Tokyo (JP); Hiroshi Fujimura, Kanagawa (JP)

(21) Appl. No.: 13/287,798

(22) Filed: Nov. 2, 2011

(30) Foreign Application Priority Data
Mar. 30, 2011 (JP) 2011-076171

(51) Int. Cl. G10L 15/26

(52) U.S. Cl. 704/235; 704/E15.043

(57) ABSTRACT

According to embodiments, a voice inputting unit converts voice into a digital signal. The state detecting unit includes an acceleration sensor, and detects movement and/or a state of an equipment main body. The holding unit stores movement or state pattern models of predetermined movement or a state of the equipment main body and predetermined voice recognition process patterns corresponding to the models. The pattern detecting unit detects whether or not movement and/or a state of the equipment main body from the state detecting unit matches the movement or state pattern models stored in the holding unit, and detects a voice recognition process pattern corresponding to the matched model. The voice recognition process executing unit executes the voice recognition process on the digital signal output from the voice inputting unit according to the detected voice recognition process pattern.

### CROSS-REFERENCE TO RELATED APPLICATION

This application is based upon and claims the benefit of priority from the Japanese Patent Application No. 2011-76171, filed on Mar. 30, 2011; the entire contents of which are incorporated herein by reference.

### FIELD

Embodiments described herein relate generally to a voice recognition device and a voice recognition method that can convert voice into text and receive the text, and receive voice as a voice command.

### BACKGROUND

In recent years, mobile terminal equipment such as smartphones and slate (or tablet) PCs that can be operated through a touch-panel display without a keyboard has been developed and has been becoming common.

Such mobile terminal equipment (hereinafter, also simply referred to as terminal equipment) has a plurality of functions, means of calling, and means of communication. The functions include a function to obtain a document from voice by converting the voice into text and receiving the text and a function to receive voice as a voice command to control editing text and operations of various applications by using a voice recognition technique.

In such terminal equipment that can recognize voice, it is difficult for the terminal equipment to automatically determine whether voice being made by a user is to be input as text or as a voice command to control operations. In addition, if users operate a button to switch one input mode to the other based on such intentions, it is necessary for the users to check a position of the button and then operate the button, which will be a burden for the users.

### BRIEF DESCRIPTION OF THE DRAWINGS

FIG. 1 is a block diagram of a voice recognition device according to a first embodiment;

FIG. 2 is a schematic block diagram of an equipment main body of mobile terminal equipment mounting a voice recognition device of embodiments;

FIG. 3 is a flow chart showing an operation of the voice recognition device according to the first embodiment; and

FIG. 4 is a flow chart showing an operation of a voice recognition device according to a second embodiment.

### DETAILED DESCRIPTION

A voice recognition device of embodiments includes a voice inputting unit configured to receive voice, convert the voice into a digital signal, and output the signal; a state detecting unit; a movement or state pattern model holding unit; a pattern detecting unit; and a voice recognition process executing unit. The state detecting unit includes an acceleration sensor, and detects and outputs movement and/or a state of an equipment main body mounting the device. The movement or state pattern model holding unit stores movement or state pattern models of predetermined movement and/or a state of the equipment main body, and predetermined process patterns of a plurality of voice recognition processes corresponding to the movement or state pattern models. The pattern detecting unit detects whether or not movement and/or a state of the equipment main body outputted from the state detecting unit matches the movement or state pattern models stored in the movement or state pattern model holding unit, detects a process pattern of a voice recognition process corresponding to the matched movement or state pattern model, and outputs the detected process pattern. The voice recognition process executing unit executes the voice recognition process on the digital signal outputted from the voice inputting unit according to the process pattern of the voice recognition process outputted from the pattern detecting unit.

The voice recognition device according to the embodiments of the present invention will be described below with reference to the drawings.

### First Embodiment

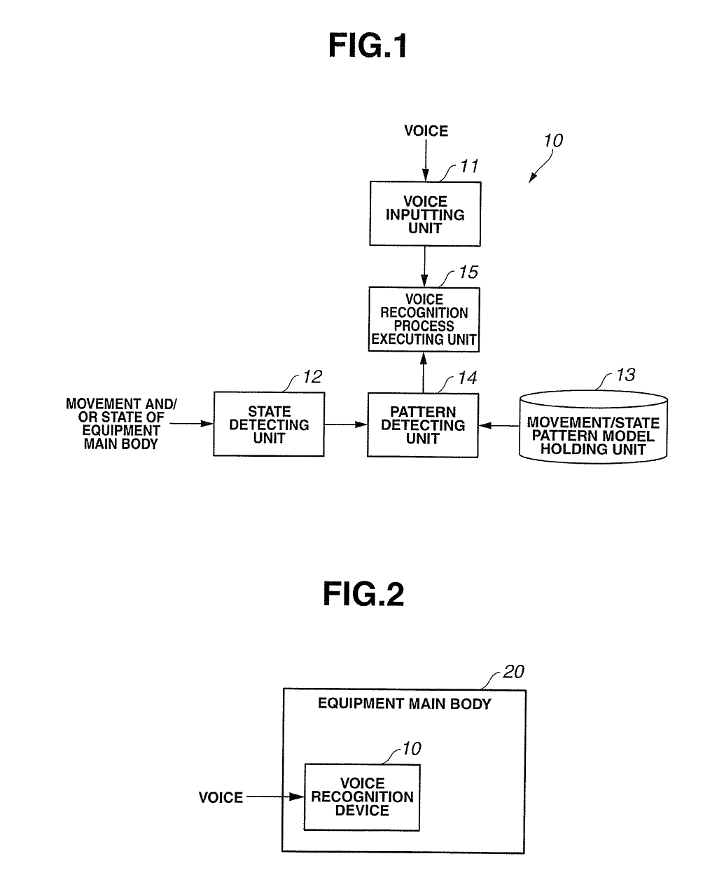

FIG. 1 is a block diagram of a voice recognition device according to a first embodiment.

In FIG. 1, a voice recognition device 10 includes a voice inputting unit 11, a state detecting unit 12, a movement or state pattern model holding unit 13, a pattern detecting unit 14, and a voice recognition process executing unit 15. The voice recognition device 10 is mobile terminal equipment such as smartphones and slate (or tablet) PCs.

The voice inputting unit 11 receives voice, converts the voice into a digital signal, and outputs the signal.

The state detecting unit 12 includes an acceleration sensor, and detects and outputs movement and/or a state of an equipment main body mounting the device. The movement and/or the state refers to any movement of the equipment main body, a state in which the main body is in a horizontal position or inclined at least a certain degree from the horizontal, or a state in which both movement and inclination are taken into consideration (account).

The acceleration sensor is a triaxial acceleration sensor, for example. The triaxial acceleration sensor can obtain a magnitude and a direction of acceleration in three-dimensional space by using three sensors of detection axes x, y, and z, which are orthogonal to each other, and compose the obtained magnitude and direction into a vector component to detect a magnitude and a direction of the acceleration.

The movement or state pattern model holding unit 13 stores movement or state pattern models of predetermined movement or a state of the equipment main body and predetermined process patterns of a plurality of voice recognition processes corresponding to the movement or state pattern models. The plurality of voice recognition processes include, for example, at least a process to convert voice into text and a process to receive voice as a command to operate a predetermined application with the command. In addition, the process patterns mean contents or types of the processes.

The pattern detecting unit 14 detects whether or not movement and/or a state of the equipment main body detected by the state detecting unit 12 matches the movement or state pattern models stored in the movement or state pattern model holding unit 13, detects a process pattern of a voice recognition process corresponding to the matched movement or state pattern model, and outputs the detected process pattern.

The voice recognition process executing unit 15 executes the voice recognition process on the digital signal outputted from the voice inputting unit 11 according to the process pattern of the voice recognition process outputted from the pattern detecting unit 14.

As illustrated in FIG. 2, the voice recognition device 10 of the present embodiment is mounted on the equipment main body 20 of the mobile terminal equipment. In other words, the mobile terminal equipment is the voice recognition device 10. The equipment main body 20 has a configuration of a plate-like form (called slate or tablet), for example, and at least one of surfaces of the equipment main body 20 has a display, on which a function menu is displayed to enable various functions including voice recognition, recording, calling, and communicating to be performed. The equipment main body 20, which has the plate-like form and provided with the display on the surface, may be set in a slightly inclined state with respect to a vertical direction by using, for example, a separate or an accessory stand or may be set in a horizontal position or slightly inclined from the horizontal. In other words, a setting device such as a stand which can adjust inclination (an inclination angle) of the equipment main body 20 may be used to set (or fix) the equipment main body 20 with any inclination angle such as 0 to 90 degrees to a horizontal plane.

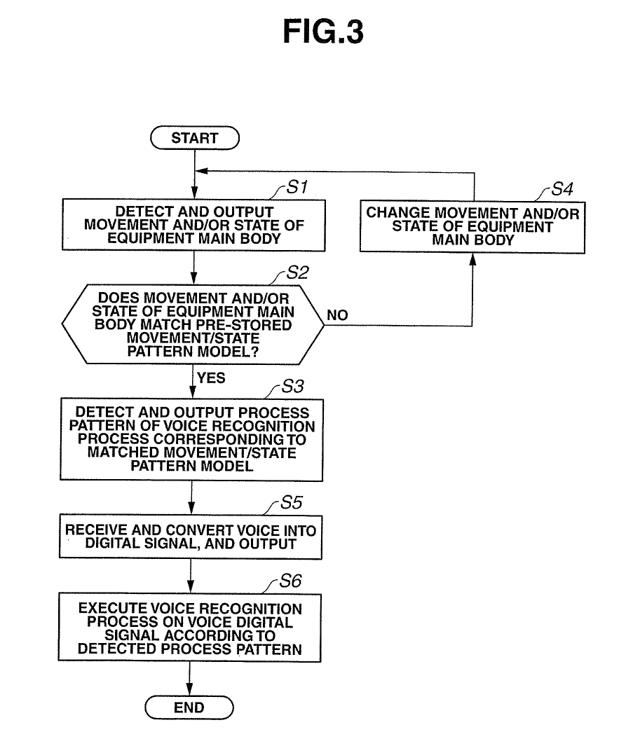

Next, an operation of the voice recognition device 10 according to the first embodiment will be described with reference to a flow chart in FIG. 3.

In a description of the following operation, it is assumed that the movement or state pattern model holding unit 13 stores (or registers) the movement or state pattern models of the predetermined movement or states of the equipment main body, and predetermined process patterns of a plurality of the voice recognition processes corresponding to the movement or state pattern models. It is also assumed that the equipment main body has been turned on prior to the operations of the following steps.

First, in step S1, the state detecting unit 12 detects and outputs movement and/or an inclined state of the equipment main body.

Next, in step S2, the pattern detecting unit 14 detects whether or not the movement and/or the state of the equipment main body detected by the state detecting unit 12 matches the movement or state pattern models stored in the movement or state pattern model holding unit 13. If the movement and/or the state matches the models, the processing proceeds to step S3. If the movement and/or the state does not match the models, the processing proceeds to step S4, where a user gradually changes the movement or the state of the equipment main body so as to change the movement and/or the state of the equipment main body, while the processing returns to step S1 and then proceeds to step S2. The flow is repeated, and thereby a matched state is obtained in step S2, and then the processing can proceed to step S3.

In step S3, the pattern detecting unit 14 detects a process pattern of the voice recognition process corresponding to the matched movement or state pattern model, and outputs the detected process pattern.

In step S5, in the state, the voice inputting unit 11 receives voice from outside through a microphone (not shown), converts the voice into a digital signal, and outputs the signal.

Next, in step S6, the voice recognition process executing unit 15 executes the voice recognition process on the digital signal outputted from the voice inputting unit 11 according to the process pattern of the voice recognition process outputted from the pattern detecting unit 14. In the present embodiment, the execution of the voice recognition process refers to execution of, for example, either one of the processes to convert voice into text and the process to receive voice as a command to operate a predetermined application with the command.

According to the first embodiment, the user can easily perform appropriate one of the text input and the voice command input on the voice recognition only by moving and/or inclining the equipment, without a burden that the user switches one input to the other by operating a button. In addition, even if voice information identical to a voice command is inputted, appropriate one of the text input and the voice command input can be performed.

### Second Embodiment

A voice recognition device according to a second embodiment has the same configuration as FIG. 1, so that illustration is omitted. First, a function of each component in the second embodiment will be described with the same reference numerals as those assigned to blocks in FIG. 1.

The voice inputting unit 11 receives voice, converts the voice into a digital signal and outputs the signal.

The state detecting unit 12 includes an acceleration sensor, and detects and outputs an inclination angle with respect to a horizontal direction of the equipment main body mounting the device.

The movement or a state pattern model holding unit 13 holds a threshold value preset for the inclination angle with respect to the horizontal direction of the equipment main body mounting the device, the angle being output from the state detecting unit 12, and stores (or registers) process patterns for different voice recognition processes for a case in which the angle exceeds the threshold value and for a case in which the angle does not exceed the threshold value.

The pattern detecting unit 14 compares the inclination angle with respect to the horizontal direction of the equipment main body, the angle being output from the state detecting unit 12, with the threshold value for the inclination angle held by the movement or state pattern model holding unit 13. If the angle exceeds the threshold value, the pattern detecting unit 14 detects and outputs the process pattern for the voice recognition process executed when the threshold value is exceeded, and if the angle does not exceed the threshold value, the pattern detecting unit 14 detects and outputs the process pattern for the voice recognition process executed when the threshold value is not exceeded.

The voice recognition process executing unit 15 executes the voice recognition process on the digital signal outputted from the voice inputting unit 11 according to the process pattern of the voice recognition process outputted from the pattern detecting unit 14.

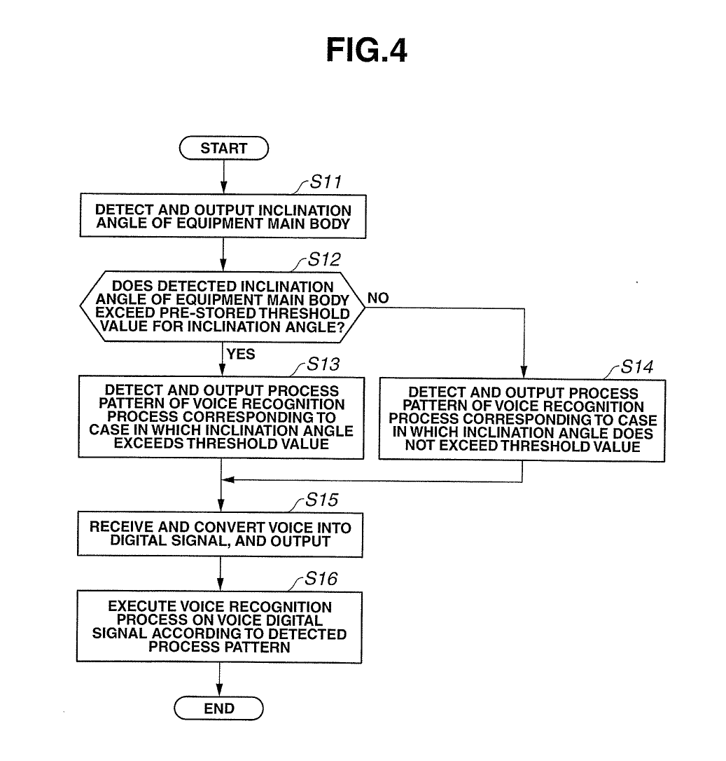

Next, an operation of the voice recognition device 10 according to the second embodiment will be described with reference to a flow chart in FIG. 4.

In a description of the following operation, it is assumed that the movement or state pattern model holding unit 13 stores (or registers) movement or state pattern models of predetermined inclination angles of the equipment main body, and predetermined process patterns of a plurality of voice recognition processes corresponding to the movement or state pattern models. It is also assumed that the equipment main body has been turned on prior to the operations in the following steps.

First, in step S11, the state detecting unit 12 detects and outputs an inclination angle of the equipment main body.

Next, in step S12, the pattern detecting unit 14 detects whether or not the inclination angle of the equipment main body detected by the state detecting unit 12 exceeds the threshold value for the inclination angle stored in the movement or state pattern model holding unit 13. If the inclination angle exceeds the threshold value, the processing proceeds to step S13.

In step S13, the pattern detecting unit 14 detects and outputs a process pattern of the voice recognition process corresponding to a case in which the inclination angle exceeds the threshold value.

In step S15, in the output state of S13, the voice inputting unit 11 receives voice from outside through a microphone (not shown), converts the voice into a digital signal, and outputs the signal.

Next, in step S16, the voice recognition process executing unit 15 executes the voice recognition process on the digital signal outputted from the voice inputting unit 11 according to the process pattern of the voice recognition process outputted from the pattern detecting unit 14. The execution of the voice recognition process refers to, for example, the execution of either one of the processes to convert voice into text and the process to receive voice as a command to operate a predetermined application with the command.

On the other hand, in step S12, the inclination angle does not exceed the threshold value, the processing proceeds to step S14.

In step S14, the pattern detecting unit 14 detects and outputs a process pattern of the voice recognition process corresponding to a case in which the inclination angle does not exceed the threshold value.

In step S15, in the output state of S14, the voice inputting unit 11 receives voice from outside through the microphone (not shown), converts the voice into a digital signal, and outputs the signal.

Next, in step S16, the voice recognition process executing unit 15 executes the voice recognition process on the digital signal outputted from the voice inputting unit 11 according to the process pattern of the voice recognition process outputted from the pattern detecting unit 14.

According to the second embodiment, a state for receiving text input and a state for receiving voice command input on the voice recognition are set for inclination angles of the equipment main body, and the user inclines the equipment main body. It is detected whether or not the inclination angle of the equipment main body exceeds the threshold value, and thereby the device can switch between the two states (modes). The user can easily perform appropriate one of the text input and the voice command input on the voice recognition only by inclining the equipment, without a burden that the user switches one input to the other by operating a button. In addition, even if voice information identical to a voice command is inputted, appropriate one of the text input and the voice command input can be performed.

According to the above-described embodiments, the user can easily perform appropriately one of the text input and the voice command input on the voice recognition only by moving and/or inclining the equipment, without a burden that the user switches one input to the other by operating a button. In addition, even if voice information identical to a voice command is inputted, appropriate one of the text input and the voice command input can be performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voice recognition device comprising:
a voice inputting unit configured to receive voice, convert the voice into a digital signal, and output the signal;
a state detecting unit configured to include an acceleration sensor, detect movement and/or a state of an equipment main body mounting the device, and output the detected movement and/or the state;
a movement or state pattern model holding unit configured to store movement or state pattern models of predetermined movement and/or a state of the equipment main body, and predetermined process patterns of a plurality of voice recognition processes corresponding to the movement or state pattern models;
a pattern detecting unit configured to detect whether or not movement and/or a state of the equipment main body outputted from the state detecting unit matches the movement or state pattern models stored in the movement or state pattern model holding unit, detect a process pattern of a voice recognition process corresponding to the matched movement or state pattern model, and output the detected process pattern; and
a voice recognition process executing unit configured to execute the voice recognition process on the digital signal outputted from the voice inputting unit according to the process pattern of the voice recognition process outputted from the pattern detecting unit.

2. The voice recognition device according to claim 1, wherein the plurality of voice recognition processes include at least a process to convert voice into text and a process to receive voice as a command to operate a predetermined application with the command.

3. The voice recognition device according to claim 1, wherein
the state detecting unit includes an acceleration sensor, and detects and outputs an inclination angle with respect to a horizontal direction of the equipment main body mounting the device;
the movement or state pattern model holding unit holds a threshold value preset for the inclination angle with respect to the horizontal direction of the equipment main body mounting the device, the angle being outputted from the state detecting unit, and stores process patterns for different voice recognition processes for a case in which the angle exceeds the threshold value and for a case in which the angle does not exceed the threshold value; and
the pattern detecting unit compares the inclination angle with respect to the horizontal direction of the equipment main body, the angle being outputted from the state detecting unit, with the threshold value for the inclination angle held by the movement or state pattern model holding unit, and if the angle exceeds the threshold value, the pattern detecting unit detects and outputs the process pattern for the voice recognition process executed if the threshold value is exceeded, and if the angle does not exceed the threshold value, the pattern detecting unit detects and outputs the process pattern for the voice recognition process executed if the threshold value is not exceeded.

4. The voice recognition device according to claim 1, further comprising a setting device configured to set the equipment main body inclined with respect to a horizontal plane and enable inclination to be adjusted.

5. The voice recognition device according to claim 1, wherein the voice recognition device is mobile terminal equipment.

6. A voice recognition method comprising:
detecting movement and/or a state of an equipment main body mounting a voice recognition device;
detecting whether or not the detected movement and/or state of the equipment main body matches the movement or state pattern models stored in a holding unit in which predetermined movement or state pattern models and predetermined process patterns of a plurality of voice recognition processes corresponding to the pattern models are stored;
detecting by a pattern detecting unit, if a matched state is detected, a process pattern of the voice recognition process corresponding to the matched movement or state pattern model; and
executing the voice recognition process on a digital signal outputted from a voice inputting unit according to the process pattern of the voice recognition process detected by the pattern detecting unit.

7. The voice recognition method according to claim 6, wherein the plurality of voice recognition processes include at least a process to convert voice into text and a process to receive voice as a command to operate a predetermined application with the command.

8. The voice recognition method according to claim 6, wherein
the movement and/or the state of the equipment main body includes an inclination angle of the equipment main body mounting the device with respect to a horizontal direction, the inclination angle being detected by an acceleration sensor;
the movement or state pattern models include process patterns for different voice recognition processes for a case in which the inclination angle exceeds a threshold value preset for the inclination angle and for a case in which the inclination angle does not exceed the threshold value; and
the detected inclination angle is compared with the threshold value, if the angle exceeds the threshold value, the voice recognition process is executed by using the process pattern for the voice recognition process executed if the threshold value is exceeded, and if the angle does not exceed the threshold value, the voice recognition process is executed by using the process pattern for the voice recognition process executed if the threshold value is not exceeded.
